(19) United States
(12) Patent Application Publication
(10) Pub. No.: US 2014/0249346 A1
(43) Pub. Date: Sep. 4, 2014

(54) PROCESS FOR STABILIZING WASTE

(71) Applicant: Remedial Construction Svc., L.P., Houston, TX (US)

(72) Inventor: Steven R. BIRDWELL, Houston, TX (US)

(73) Assignee: Remedial Construction Svc., L.P., Houston, TX (US)

(21) Appl. No.: 14/067,897

(22) Filed: Oct. 30, 2013

Related U.S. Application Data
(60) Provisional application No. 61/720,260, filed on Oct. 30, 2012.

(51) Int. Cl. A62D 3/36

(52) U.S. Cl. CPC A62D 3/36; A62D 2101/20
USPC 588/318

(57) ABSTRACT

The process for stabilizing wastes generally comprises blending spent or virgin fullers earth with a hazardous or non-hazardous sludge, soil or sediment to form a matrix. Next, the matrix is blended with a reagent capable of growing a calcium silicate hydrate or Ettringite mineral. In this manner a more stable, less leachable product is formed.

### CROSS-REFERENCE TO RELATED APPLICATION

This application claims priority to provisional U.S. application 61/720,260 filed Oct. 30, 2013 which is incorporated herein by reference.

### FIELD OF THE INVENTION

The present invention pertains to, for example, a Neutralization/Solidification/Stabilization (NSS) process for stabilizing waste using, for example, a reagent capable of growing a calcium silicate hydrate and Ettringite mineral.

### BACKGROUND AND SUMMARY OF THE INVENTION

Stabilization of waste is increasingly important. Unfortunately, current methods are often not economical, efficient, and/or environmentally sound for particularly difficult areas. Fortunately, the current invention and methods offer an attractive solution and may be particularly useful in, for example, stabilization of sludges comprising high organic content such as oil. This includes, for example, acid tar sludges and Manufactured Gas Plant sludges.

The process for stabilizing wastes generally comprises blending spent or virgin fullers earth, clay, or a mixture thereof with a hazardous or non-hazardous sludge, soil or sediment to form a matrix. Next, the matrix is blended with a reagent capable of growing a calcium silicate hydrate and Ettringite mineral. In this manner a more stable, less leachable product is formed.

In another embodiment, the process for stabilizing waste comprises first neutralizing an acidic waste composition. Specifically, the acidic waste composition comprises hazardous sludge, non-hazardous sludge, soil, sediment, or a mixture thereof. The waste composition is contacted with a lime composition to form a neutralized waste under conditions sufficient to change the pH to from about 8 to about 12.5 according to BS EN 12457-4:2002. The neutralized waste composition is blended with a bulking agent comprising clay, organoclay, activated clay, spent fullers earth, virgin fullers earth, or a mixture thereof in an amount and under conditions sufficient to form a bulked composition. Next, the bulked composition is blended with Portland cement, slag cement, granulated glass fume slag, Class C fly ash, circulating fluidized bed ash, fluidized bed ash, or a mixture thereof and water in amounts and under conditions sufficient to convert the bulked composition to a stabilized waste. The stabilized waste usually has one or more of the following characteristics: (a) a compressive strength of at least about 20 psi according to ASTM D 1633; (b) a compressive strength of at least about 7 psi according to ASTM D 2166; (c) a compressive strength of at least about 7 psi according to ASTM 4832; (d) a hydraulic conductivity of less than about 1×10⁻⁵ cm/sec according to ASTM D 5084; (e) a 120 hour leachability of mercury of less than about 20 μg/L according to modified ANS 16.1; (f) a 120 hour leachability of benzene of less than about 50 μg/L according to modified ANS 16.1; (g) a 120 hour leachability of iron of less than about 3000 μg/L according to modified ANS 16.1; (h) a 120 hour leachability of manganese of less than about 3000 μg/L according to modified ANS 16.1; (i) a 120 hour leachability of aluminum of less than about 20,000 μg/L according to modified ANS 16.1; (j) a 120 hour leachability arsenic of less than about 100 μg/L according to modified ANS 16.1; (k) a 120 hour leachability of cadmium of less than about 50 μg/L according to modified ANS 16.1; and (l) a 120 hour leachability of lead of less than about 150 μg/L according to modified ANS 16.1. The full details of all test methods and procedures referenced in this application are incorporated by reference and absent a contrary indication refer to the method or procedure in effect at the time of filing.

### BRIEF DESCRIPTION OF THE DRAWINGS

FIG. 1 is an NSS Grid Layout for the project detailed in the examples.

FIG. 2 shows the existing conditions (top of sludge) prior to undertaking the project detailed in the examples.

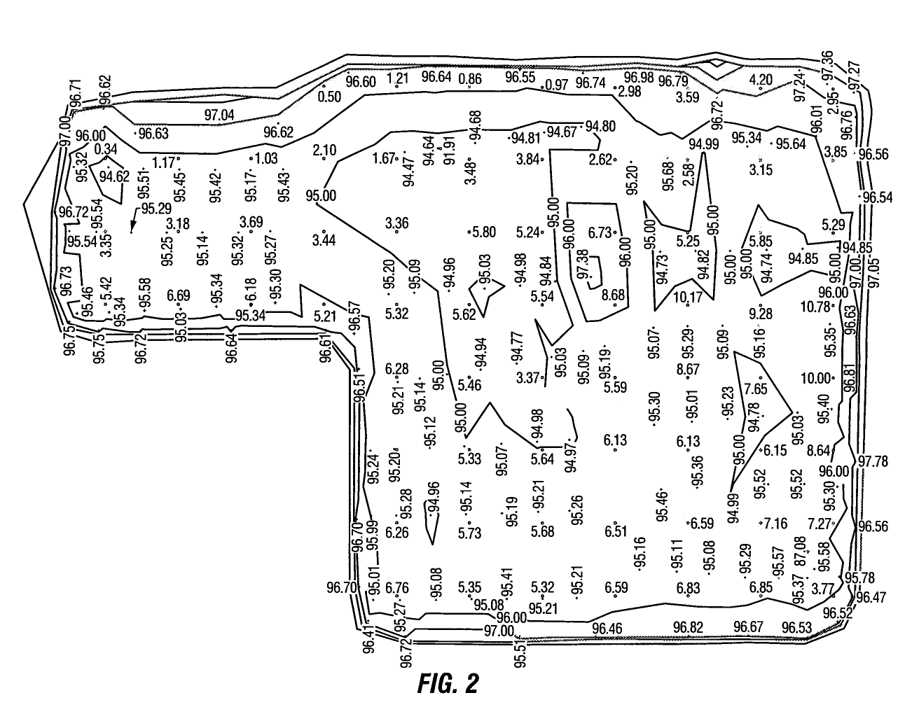

FIG. 3 shows the existing conditions (depths) prior to undertaking the project detailed in the examples.

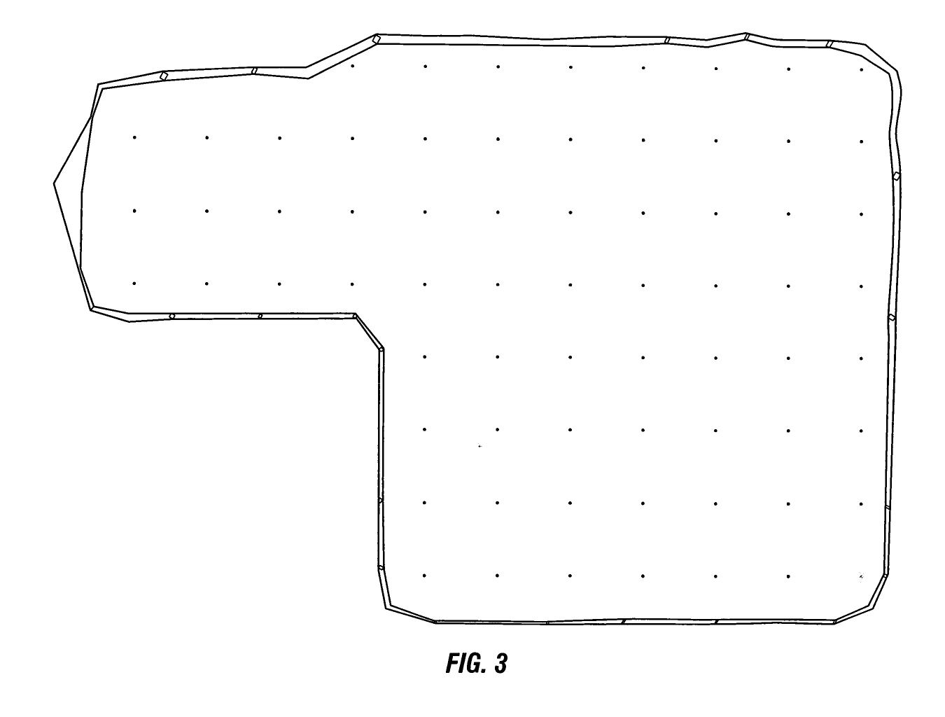

FIG. 4 shows the existing conditions (depths) prior to undertaking the project detailed in the examples.

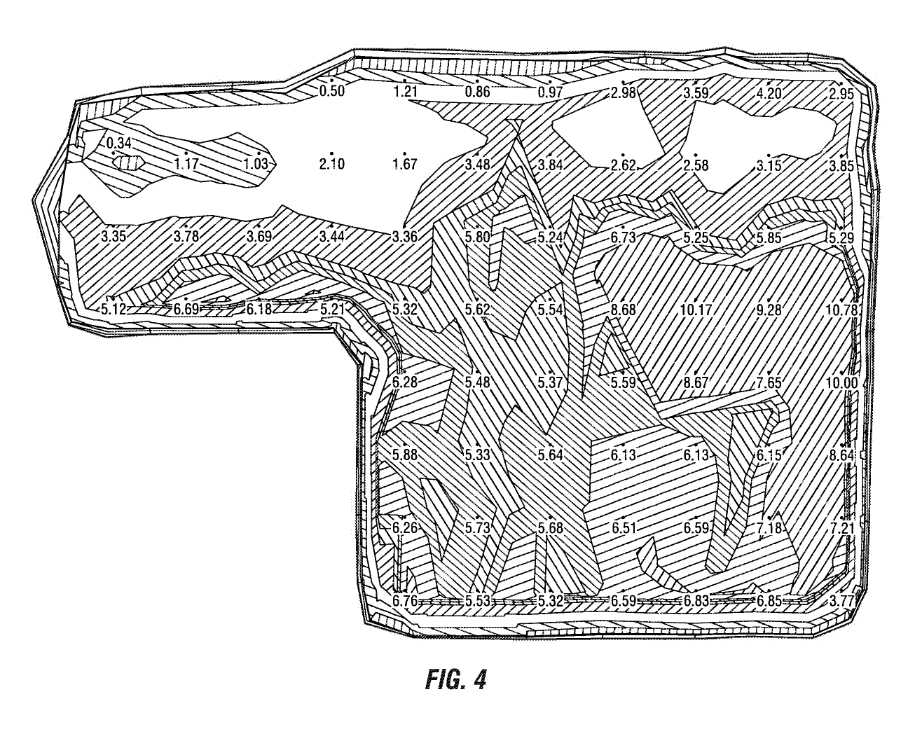

### DETAILED DESCRIPTION OF THE INVENTION

The present invention pertains to a process for stabilizing waste. While many wastes may benefit from the instant invention it is particularly applicable to acidic waste compositions. More specifically, it is usually advantageously employed to acidic waste compositions having a pH of from about 0 up to about 4, or up to about 3. Such wastes are often not naturally occurring and may be the result of, for example, chemical, petrochemical, petroleum, or other operation. Such operations may result in waste compositions like oil waste, acid tar sludge, or manufactured gas plant sludge.

The instant process can advantageously be employed on waste compositions covering areas of over an acre, or over 5 acres, or even over 10 acres. Typically, the process is run as an in-situ batch process. Accordingly, often the stabilized waste product may comprise a volume of at least about 10,000, or at least about 20,000, or at least about 35,000, or at least about 50,000 cubic yards or more. Thus, while the blending and mixing in the process to form the stabilized waste product may be accomplished in any convenient manner it is often accomplished using heavy machinery such as excavators and the like. Suitable excavators include those with a bucket and/or rotary hydraulic mixing tool attached. As an alternative to an in-situ process it may be desirable in some applications to create one or more channels via excavation in order to allow the waste, e.g., sludge, to flow or be transferred with the blending with other ingredients occurring simultaneously or subsequently. This may be useful in situations when, for example, a sludge level is rising such that it is jeopardizing berm integrity and/or proper containment.

Generally, the acidic waste composition is first neutralized. The neutralizing agent is not particularly critical so long as it can form a neutralized waste. Typically, a lime composition is employed and contacted with the acidic waste composition under conditions sufficient to change the pH of the acidic waste composition to from about 8 to about 12.5 according to BS EN 12457-4:2002. Such contacting may occur at any temperature but it usually preferred that the temperature be above freezing so that the waste composition is easier to mix with the lime composition.

The specific lime composition and amount employed may vary depending upon the characteristics of the waste composition and desired final stabilized product. Typically, the lime composition comprises hydrated quicklime (sometimes called slaked quicklime or slurry of quicklime), lime hydrate, spent lime hydrate, lime kiln dust, high calcium quicklime, magnesian quicklime, dolomitic quicklime, high calcium hydrated lime, dolomitic hydrated lime, or a mixture thereof. Such lime compositions are added to the acidic waste composition in an amount to change the pH of the acidic waste composition to from about 8, or from about 9, up to about 12.5, or up to about 11.5. The amount of lime added varies, of course, depending upon the lime composition but often it is at least about 4, or at least about 5, or least about 8%, up to about 20, or up to about 18, or up to about 15% by weight based on the total weight of acidic waste composition.

Usually, for very acidic and/or high sulfur containing wastes it is preferred to employ a stronger base in order to facilitate an aggressive reaction and faster neutralization. In this manner, emission of gases comprising sulfur such as H₂S and SO₂ may be reduced or even eliminated. It also advantageous to maintain the pH in order to, for example, inhibit such gas formation over an extended period. Therefore, in some cases the pH after said neutralizing step is from about 9 to about 12.5 according to BS EN 12457-4:2002 and the pH does not vary by more than about 1.25, or by not more than 1, or by not more than 0.5 units for at least five days or even at least seven days following the neutralizing step.

In some cases the acidic waste composition may be an acid tar sludge comprising asphaltene. In such cases it may be useful to demulsify the asphaltene. There are a number of compositions that may be usefully employed but typically a lime composition having greater than about 25% available lime is employed. A particularly useful one may comprise lime kiln dust, quicklime, or a mixture thereof.

In one embodiment, hydrated quicklime is employed on waste compositions with high sulfur contents. In this manner in some cases advantageously less than 5%, or less than 4%, or even less than 1% of the total sulfur present in the acidic waste composition is emitted as gas during the process.

Once a neutralized waste composition has been formed it is then blended with a bulking agent. The type and amount of bulking agent are not critical so long as it does not inhibit the formation of the final stabilized composition. When properly selected the bulking agent may assist with activating the pozzolanic reagent, i.e., Portland cement and the like, which is added to the bulked composition. In this manner, a low solids stabilization mineral, LSS, is created and grows during the subsequent curing process. Such low solids stabilization minerals include, for example, a calcium silicate hydrate or Ettringite mineral.

The specific bulking agent may vary depending upon the characteristics of the neutralized waste composition, the other ingredients, and the desired final product. Typically, the bulking agent comprises clay, organoclay such as those available from Cetco, activated clay, spent fullers earth, virgin fullers earth, or a mixture thereof. The amount added to the neutralized waste composition will vary. Typically, the bulking agent is added in an amount of from at least about 25, or at least about 35, or at least about 50, up to about 200, or up to about 150, or up to about 100% by volume based on the total volume of acidic waste composition, i.e., the volume before neutralization.

Simultaneous with adding the bulking agent or afterward, a stabilizing agent is blended with the bulked composition. The stabilizing agent is (1) Portland cement, slag cement, granulated glass fume slag, Class C fly ash, circulating fluidized bed ash, fluidized bed ash, or a mixture thereof and (2) water. These are blended in amounts and under conditions sufficient to convert the already formed or forming bulked composition to a stabilized waste. The amounts of stabilizing agent vary depending upon the ingredients in the already formed or forming bulked composition and desired characteristics of the final stabilized product. Typically, the amount added of (1) Portland cement, slag cement, granulated glass fume slag, Class C fly ash, circulating fluidized bed ash, fluidized bed ash, or a mixture thereof is at least about 5, or at least about 8 or at least about 10 weight percent based on the total weight of the bulked composition. On the other hand, the amount added of (1) is less than about 35, or less than about 30, or less than about 25 weight percent based on the total weight of the bulked composition.

The amount of water added will vary depending upon the other ingredients and the amount of water already in the composition. Of course, when the composition is exposed to the elements water may also come from rainfall and other sources besides addition. Typically, the amount of water added is at least sufficient to initiate and complete curing but not so much such that the composition is unstable. However, if too much water is added then the composition may be allowed to dry and/or active drying may be employed to reduce the water content. Typically, enough water is added to allow for the appropriate hydration reactions to occur within the blended composition. In this manner a stable composition may be formed which has at least one, or at least six, or at least eight, or at least ten, or even substantially all of the following characteristics (a) through (l).:

(a) a compressive strength of at least about 20, or at least about 25, or at least about 30, or at least about 40 psi according to ASTM D 1633;

(b) a compressive strength of at least about 7, or at least about 9, or at least about 10, or at least about 11 psi according to ASTM D 2166;

(c) a compressive strength of at least about 7, or at least about 9, or at least about 10, or at least about 11 psi according to ASTM 4832;

(d) a hydraulic conductivity of less than about 1×10⁻⁵, or less than about 1×10⁻⁶ cm/sec according to ASTM D 5084;

(e) a 120 hour leachability of mercury of less than about 20, or less than about 10, or less than about 5 μg/L according to modified ANS 16.1;

(f) a 120 hour leachability of benzene of less than about 50, or less than about 20, or less than about 10 μs/L according to modified ANS 16.1;

(g) a 120 hour leachability of iron of less than about 3000, or less than about 2500, or less than about 2000 μg/L according to modified ANS 16.1;

(h) a 120 hour leachability of manganese of less than about 3000, or less than about 2500, or less than about 2000 μg/L according to modified ANS 16.1;

(i) a 120 hour leachability of aluminum of less than about 20,000, or less than about 10,000, or less than about 3000 μg/L according to modified ANS 16.1;

(j) a 120 hour leachability arsenic of less than about 100, or less than about 25, or less than about 10 μg/L according to modified ANS 16.1;

(k) a 120 hour leachability of cadmium of less than about 50, or less than about 20, or less than about 10 μg/L according to modified ANS 16.1;

(1) a 120 hour leachability of lead of less than about 150, or less than about 20, or less than about 10 μg/L according to modified ANS 16.1;

The following examples are provided to further illustrate the invention. They are not meant to be construed as limiting the invention. Documents hereby incorporated by reference include Remedial Construction Services L.P. documents filed with the Pennsylvania regulatory authorities relating to the treatment of Sunoco, Inc. Read Boyd Farm in Marcus Hook, Pa. in Delaware County.

### Examples

Eight (8) grids and blends of reagent mix designs were prepared as listed below. This equated to mixing ˜440 Cubic Yards (CY) of approximately 42,000 CY total acid tar sludge quantity. The percentages below are based on total weight of the acid tar sludge except that the percentage of Fullers Earth or clay is based on total volume of acid tar sludge.

B-2a: 10% Lime Hydrate+33% Fullers Earth (1 part Fullers Earth to 2 parts acid tar sludge)+10% PC/20% H2O Slurry+20% CFB

B-2b: 10% Lime Hydrate+33% Fullers Earth (1 part Fullers Earth to 2 parts acid tar sludge)+10% PC/20% H2O Slurry+20% FBC

B-3a: 10% Lime Hydrate+50% Fullers Earth (1 part Fullers Earth to 1 part acid tar sludge)+10% PC/20% H2O Slurry+20% FBC

B-3b: 10% Lime Hydrate+50% Fullers Earth (1 part Fullers Earth to 1 part acid tar sludge)+10% PC/20% H2O Slurry+20% CFB

B-4a: 10% Lime Hydrate+33% Fullers Earth (1 part Fullers Earth to 2 parts acid tar sludge)+10% PC+20% CFB □ B-4b: 10% Lime Hydrate+33% Fullers Earth+10% PC+20% FBC

B-5a: 10% Lime Hydrate+33% Fullers Earth (1 part Fullers Earth to 2 parts acid tar sludge)+12.5% PC/10% H2O Slurry+25% CFB

B-5b: 10% Lime Hydrate+33% Fullers Earth (1 part Fullers Earth to 2 parts acid tar sludge)+12.5% PC/10% H2O Slurry+25% FBC

### Reagent Supply and Supplier List:

C-ash=Class C Fly ash (Note: Class C Fly Ash was unavailable for use)

CFB=Circulating Fluidized Bed ash (Kimberly Clark—Chester, Pa.)

FBC=Fluidized Bed ash (PH Glatfelter—Spring Grove, Pa.)

FE=Spent Fullers Earth (Sunoco—Read Boyd Farm)

H2O=Water (Sunoco—Read Boyd Farm onsite water source)

HL=Hydrated Lime (Carmeuse—Annville, Pa.)

LH=Spent Lime Hydrate (DuPont—Montague, Mich.)

PC=Type 1/2 Portland cement (Mintek)

Due to results of Unconfined Compressive Strength (UCS), seven (7) out of the eight (8) mixes tested had results exceeding 10 pounds per square inch (psi). Grid B-3a tested at 8-psi. Remaining samples were tested for hydraulic conductivity (permeability).

It should be noted during mixing of spent Fullers Earth, that there was quite a lot of debris intermingled with the spent Fullers Earth. Although RECON strived to separate debris from the spent Fullers Earth during excavation and prior to mixing, it was virtually impossible to remove all debris. The samples that underwent UCS were observed to be stringy in nature, which may be a result of not being able to remove all debris. Out of the seven (7) samples that exceeding 10 pounds per square inch (psi), only two (2) samples marginally passed the permeability requirements. These samples, B-2b and B-3b, were submitted for chemical analysis.

On another note, all samples were collected as “grab” samples anywhere from between 1 and 6 days of curing, and were placed in 3″ diameter by 6″ molded cylinders in four (4) layers. This was due to the presence of debris in the mix, which may not be conducive to sampling with Shelby tubes. UCS tests were completed after curing 7-days from the date of remolding samples into cylinders.

### Procurement of Reagents

Reagents were procured based on the percent dosage by weight of composite tarry sludge (˜65 pounds per cubic foot), with the exception of spent FE, which is based on volumetric dosage of composite tarry sludge. Reagents are preferably stored on-site in a manner as to not “spend” or use-up any of the reagent. Additional instructions are provided below.

### Procurement and Storage of pH Adjustment/Bulking Reagents

Spent LH is shipped in end dump trucks and stockpiled adjacent to the worksite. The storage area is graded to drain back into the pit. There is no need to cover the LH. HL was demonstrated to be effective as indicated from testing samples from “test” grids prior to full-scale use. A 5% and 10% dosage by weight of tarry sludge was blended into four (4) separate grids. HL is preferably shipped via pneumatic trucks. This material should preferably be stored in a weatherproof pit or container if it is to be stockpiled. Another acceptable means is to convey the HL into respective grids through dust control boxes with filters.

An additional pH Adjustment reagent may be used such as a locally produced spent lime hydrate (SLH) product. SLH may be shipped to the site in end dump trucks and stockpiled. Preferably, the area is graded to drain back into the pit. There is usually no need to cover the SLH. If the chemical makeup of SLH is very different than the LH, then one may consider employing a 10% dosage by weight of tarry sludge in two (2) separate grids.

Spent FE may usually be stockpiled on the site, preferably under a vegetative or other cover. Removal of FE from the stockpile may be performed on an as needed basis per day. Typically, if there is a large amount of debris then it may useful to segregate some or all of the debris from the FE prior to loading. If necessary, erosion controls may be employed on site to facilitate the storage of materials and the process.

### Procurement and Storage of Solidification/Stabilization Reagents

Portland cement, Type 1/2, may be shipped to the site in pneumatic tank trucks. Water may be transported as needed from an on-site or off-site water source using an over-the-road water truck, pipe, or any other convenient means.

FBC ash may be shipped to the site in truckload quantities and, if desired, stored on-site in a weatherproof pit or other convenient way. A loader can be used to transfer FBC where needed. CFB ash may be shipped in truckload quantities and, if desired, stored on-site in a weatherproof pitor other convenient way. A loader can be used to transfer CFB where needed.

### NSS Test Means and Methods

Six (6) test grids that failed either UCS or Permeability (B-2a, B-3a, B-4a, B-4b, B-5a and B-5b) in the Field Demonstration test will be re-sampled and re-tested after 28-days of curing.

It may be appropriate to divide the site into grids and make adjustments for elevation and sounding. The slopes of any pit may be taken into consideration, including any sludge depth, and weight of tarry sludge. Grids can then be laid out and a path to stabilization decided. A grid mix may be designed based on the composition of each grid or the site as a whole. In this manner, more than one grid mix may be employed due to initial composition, desired results, or ingredient availability constraints.

The following is one example of a step by step procedure which may be modified depending upon the waste site, ingredients, and desired results.

1. The depth of each grid is judged approximately, by using the excavator to reach through the sludge, to hard pan, in a manner so that gradation marks of one foot (1.0′) on a boom can be used to determine depth for grid length calculations. 2. The two (2) near corners of each grid are marked with a survey marker, while using a PVC pipe marked at fifteen feet (15.0′) to show location of far corners. 3. The neutralization or pH adjustment step may be performed first to not only raise the pH of the waste, e.g., acid tar, in preparation for stabilization, but also to homogenize the sludge and potentially assist in minimizing SO₂ and H₂S emissions. LH is delivered and dumped directly into respective grids or in its designated pit area and brought to the grid using a loader. Grids are mixed with LH using a hydraulic excavator at the prescribed percent dosage by weight of tarry sludge. The reagent is spread over the respective grid using the bucket of the excavator, and then mixed to depth. The time it takes to adequately blend in the pH adjustment reagents may be monitored and recorded. The pH is usually expected to rise above about 9.0 units on contact.

4. The next step will usually include blending-in the FE at the prescribed volumes. An excavator is used to sift through the FE stockpiles and, if necessary, can segregate debris from the FE as practical. Dump trucks may be used to deliver the FE to either the designated storage pit or grid. The excavator that mixed in the LH may blend in the FE by first spreading the FE over the grid and then mixing to depth. The bulking step may then add, for example, clay “fines” to the tarry sludge to give the sludge more particles for the stabilization reagents to bind to. The time it takes to adequately blend in the bulking reagents may be monitored and recorded.

5. The pozzolanic reagent, PC, can then be distributed over the respective grids. The PC is discharged via pneumatic truck, preferably through dust control apparatus, in the designated storage pit area or grid. The PC is usually spread evenly over the grid using an excavator bucket. After introducing the PC onto the sludge, an excavator bucket can be used to mix-in the reagent. A water truck, pipe, or other means can add water during mixing based on a known volume (gallon). The time it takes to adequately blend in the pozzolanic reagents may be monitored and recorded.

6. FBC or CFB ash may be cut or blended into the treated sludge in order to activate the pozzolanic reagent, create the Low Solids Stabilization (LSS) mineral and/or accelerate the curing process. These activating reagents will be stored in pits or delivered to respective grids using dump trucks. An excavator can be used to evenly spread a prescribed amount or tonnage over the grid to be mixed, and will mix the reagent into the grid to prescribed depths. The time it takes to adequately blend in these stabilization reagents may be monitored and recorded.

7. Usually within the next day or thereafter, a large majority of treated sludge may be excavated from the grid. If desired, treated sludge, preferably approximately 2-feet, may be left at the top in-place on the interior edge of each respective grid to hold-back any untreated sludge from entering the excavation. It may be useful to back this up by backfilling pre-stabilized material stockpiled nearby. The degree of slope left in-place may be decided and recorded for future reference as to mixing or otherwise. This may be a visual estimate, so as to maintain a distance from any unstable sludge wall and/or any open pit area.

8. X, Y and Z locations may be obtained along the bottom of the excavation, with one, two, or more locations recorded for final volume computations.

9. The excavated material may be stockpiled in an area near the excavator, so as to allow adequate work area for back-fill of excavated grid. The material may be placed in a manner to natural “cool-off” time of the treated material due to any heat of hydration that will take place. When the temperature of the material is the same as the untreated sludge, which may take a day or two, the treated material can be returned to its excavation and placed in layers tamped with the bottom of the bucket of the excavator. Backfilling of treated material can start along the stabilized material left in-place and work towards the bank in two the three foot thick lifts. Actual lift thickness that works best may be monitored and recorded for future guidance. This may be a visual estimate, so as to maintain a distance from any unstable sludge wall and/or any open pit area.

Off-Gas Monitoring

Throughout the pH adjustment/homogenization, and stabilization process, the breathing zone may be monitored continuously during full-scale NSS to dictate the level of protection.

Sampling and Analysis Plan

Samples of treated material are usually collected in mid-point of the depth of stabilized material, in the middle of each designated sampling grid (based on frequency set forth herein) approximately one week after backfilling and tamping in the excavated material. The samples may be geotechnically tested per the table shown on the following page. Regarding Unconfined Compressive Strengths (UCS), ASTM D 1633 will be used on molded cylinder samples, and ASTM 2166 on samples collected in tubes. Below is a summary comparison of procedures but the full method should be referenced.

ASTM D 1633

This procedure is intended for molded samples of soil-cement. The loading rate for this procedure is 20+/−10 psi/second. Failure is recorded to the nearest 10 lbs and compressive strength is recorded to the nearest 5 psi. Recording the stress-strain relationship is usually not required in this procedure.

ASTM D 2166

This procedure is typically used with samples obtained with Shelby tube samplers. The loading rate is based on % strain/time which can be varied depending on the strength of the sample (½% to 2% strain per minute). Stress-strain relationship is recorded throughout the test. Compressive strength is recorded to the nearest 0.01 tsf (0.14 psi)

Grab samples may be collected from the same area using the excavator, and sample jars provided by the chemical analysis laboratory may be filled and preserved accordingly. The samples may be analyzed for the constituents listed in the table below.

If a grid does not pass the geotechnical and chemical criteria but passes pH criteria, then the grid may be re-mixed with the stabilization reagents only. If the test fails pH criteria, then the grid may be remixed using all reagents, except perhaps the FE bulking agent.

TABLE 1
POST-TREATMENT TESTS AND FREQUENCY

| Test | Test Method | Frequency |
|---|---|---|
| 7-day | ASTM D1633 | Every 3rd grid |
| Unconfined Compressive | or D2166 | (one grid = 855 sf). |
| Strength (UCS) | | |
| 28-day UCS | ASTM D1633 | Every 3rd grid. |
| | or D2166 | If 7-day UCS exceeds |
| | | 10-psi, forego running |
| | | the 28-day test. |
| Hydraulic | ASTM D5084 | Every 12th |
| Conductivity (HC) | | grid. |
| Paint Filter | USEPA 9095 | Every 3rd grid. |
| pH | BS EN 12457- | Every 3rd grid. |
| | 4:2002 | |
| Short-term | USEPA 1312 | Every 6th grid. |
| Leachability (SPLP; 28-day | | |
| test) Arsenic Cadmium Lead | | |
| Mercury | | |
| Long Term | Modified ANS | Every 12th |
| Leachability (29th-56th day | 16.1 | grid. |
| test) Benzene Iron Manganese | | |
| Aluminum Arsenic Cadmium | | |
| Lead Mercury | | |

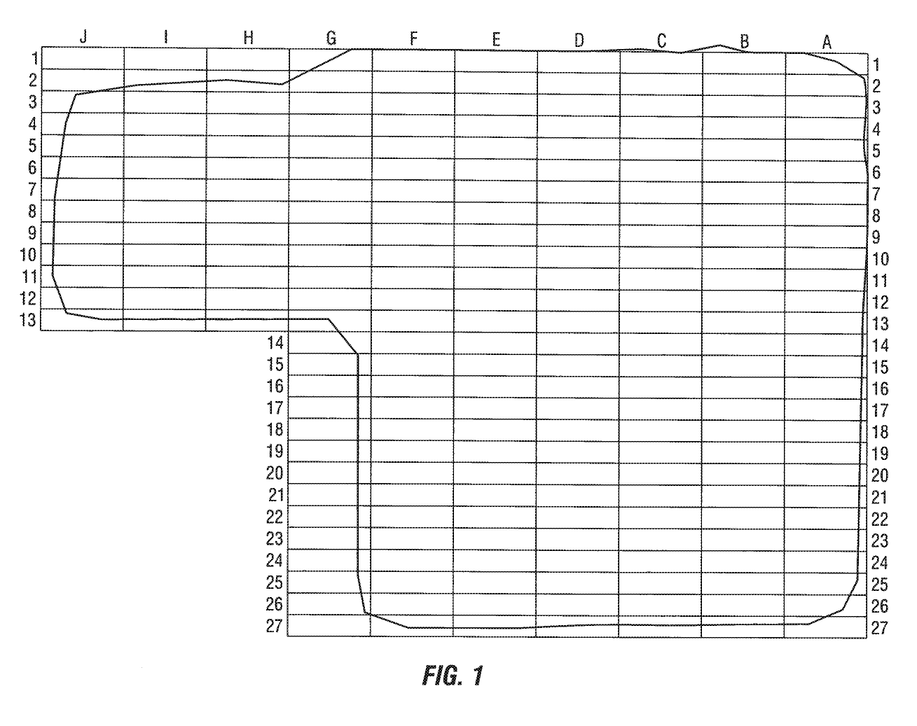

A copy of the final grid layout is shown in FIG. 1 hereto. Test Results are provided in the Appendix of Tables which follows. Test data shown includes UCS, hydraulic conductivity, paint filter test results, pH test results, short term leachability, and long term (24, 48, 72, 96, and 120 hour) leachability for various samples in the project detailed here.

HM-10% is treatability using tar sample with 10% hydrated Mintek lime. HM-15% is treatability using tar sample with 15% hydrated Mintek lime. HM-20% is treatability using tar sample with 20% hydrated Mintek lime.

The Field Demonstration Pilot Test was performed from the bank to 4 grid widths from the bank, which is not representative of the vast majority of the tarry sludge requiring pH adjustment, solidification and stabilization. As one moves into more representative material, the permeabilities look much lower. It is believed that the samples were friable due to the lack of tarry sample. pH ranges have dropped outside of the 0.5 pH range in 3 cases. All final 5-day pH results are >9.0, which is in the desired range of 8.5 to 12.5 that immobilizes most metals. As one can see with respect to the chemical analysis, leachable metals and benzene is not an issue.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A process for stabilizing waste comprising:
neutralizing an acidic waste composition comprising hazardous sludge, non-hazardous sludge, soil, sediment, or a mixture thereof by contacting said waste composition with a lime composition to form a neutralized waste under conditions sufficient to change the pH to from about 8 to about 12.5 according to BS EN 12457-4:2002;
blending the neutralized waste composition with a bulking agent comprising clay, spent fullers earth, virgin fullers earth, or a mixture thereof in an amount and under conditions sufficient to form a bulked composition; and
blending (1) Portland cement, slag cement, granulated glass fume slag, Class C fly ash, circulating fluidized bed ash, fluidized bed ash, or a mixture thereof with (2) the bulked composition and (3) water in amounts and under conditions sufficient to convert the bulked composition to a stabilized waste having one or more of the following characteristics:
(a) a compressive strength of at least about 20 psi according to ASTM D 1633;
(b) a compressive strength of at least about 7 psi according to ASTM D 2166;
(c) a compressive strength of at least about 7 psi according to ASTM 4832;
(d) a hydraulic conductivity of less than about 1×10⁻⁵ cm/sec according to ASTM D 5084; and
(e) a 120 hour leachability of lead of less than about 150 μg/L according to modified ANS 16.1.

2. The process of claim 1 wherein the lime composition is added to the acidic waste composition in an amount of from about 5 to about 20% by weight based on the total weight of acidic waste composition.

3. The process of claim 1 wherein the bulking agent is added to the neutralized waste composition in an amount of from about 25 to about 200% by volume based on the total volume of acidic waste composition before neutralization.

4. The process of claim 1 wherein the pH after said neutralizing step is from about 9 to about 12.5 according to BS EN 12457-4:2002 and wherein the pH does not vary by more than about 1 unit for five days following the neutralizing step.

5. The process of claim 1 wherein the stabilized waste has four or more of the characteristics (a) through (e).

6. The process of claim 1 wherein the stabilized waste has substantially all of the characteristics (a) through (e).

7. The process of claim 1 wherein the lime composition comprises hydrated quicklime, lime hydrate, spent lime hydrate, lime kiln dust, high calcium quicklime, magnesian quicklime, dolomitic quicklime, high calcium hydrated lime, dolomitic hydrated lime, or a mixture thereof.

8. The process of claim 1 wherein the lime composition comprises hydrated quicklime.

9. The process of claim 1 wherein the process is a batch process and the product of said batch comprises a volume of at least about 10,000 cubic yards.

10. The process of claim 1 wherein the blending employs one or more excavators with a bucket or rotary hydraulic mixing tool attached.

11. The process of claim 1 wherein the acidic waste composition has a pH of from about 0 to about 3.

12. The process of claim 1 wherein the waste composition is an oil waste, acid tar sludge, or manufactured gas plant sludge.

13. The process of claim 1 wherein less than 5% of the total sulfur present in the acidic waste composition is emitted as gas during the process.

14. The process of claim 1 wherein the acidic waste composition is an acid tar sludge comprising asphaltene.

15. The process of claim 14 wherein the process further comprises demulsifying asphaltene with a lime composition comprising greater than about 25% available lime.

16. A process for stabilizing wastes comprising:
(a) blending fullers earth, clay, or a mixture thereof with a hazardous or non-hazardous sludge, soil or sediment to form a matrix; and
(b) blending the matrix with a reagent capable of growing a calcium silicate hydrate and Ettringite mineral and thereby obtaining a product having increased strength and decreased leachability as compared to the hazardous or non-hazardous sludge, soil or sediment.

17. The process of claim 16 wherein the reagent capable of growing a calcium silicate hydrate and Ettringite mineral comprises circulating fluidized bed ash.

18. The process of claim 16 wherein the reagent capable of growing a calcium silicate hydrate and Ettringite mineral comprises fluidized bed ash.

19. The process of claim 16 wherein the product is characterized by the following characteristics:
(a) a compressive strength of at least about 7 psi in 7 days and 10 psi in 28 days according to ASTM D 2166;
(b) a hydraulic conductivity of less than about 1×10⁻⁵ cm/sec according to ASTM D 5084; and
(c) a 120 hour leachability of lead of less than about 150 μg/L according to modified ANS 16.1.

20. A process for stabilizing waste comprising:
neutralizing an acidic waste composition comprising hazardous sludge, non-hazardous sludge, soil, sediment, or a mixture thereof by contacting said waste composition with a lime composition in an amount of from about 5 to about 20% by weight based on the total weight of acidic waste composition wherein the pH after said neutralizing step is from about 9 to about 12.5 according to BS EN 12457-4:2002 and wherein the pH does not vary by more than about 1 unit for at least five days following the neutralizing step
blending the neutralized waste composition with from about 25 to about 200% by volume of a bulking agent based on the total volume of acidic waste composition wherein the bulking agent comprises clay, spent fullers earth, virgin fullers earth, or a mixture thereof under conditions sufficient to form a bulked composition; and
blending (1) Portland cement, slag cement, granulated glass fume slag, Class C fly ash, circulating fluidized bed ash, fluidized bed ash, or a mixture thereof with (2) the bulked composition and (3) water in amounts and under conditions sufficient to convert the bulked composition to a stabilized waste having the following characteristics:
(a) a compressive strength of at least about 20 psi according to ASTM D 1633;
(b) a compressive strength of at least about 7 psi according to ASTM D 2166;
(c) a compressive strength of at least about 7 psi according to ASTM 4832;
(d) a hydraulic conductivity of less than about 1×10⁻⁵ cm/sec according to ASTM D 5084; and
(e) a 120 hour leachability of lead of less than about 150 μg/L according to modified ANS 16.1.
